(19) United States
(12) Patent Application Publication
(10) Pub. No.: US 2023/0281573 A1
(43) Pub. Date: Sep. 7, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(21) Appl. No.: 18/151,736

(22) Filed: Jan. 9, 2023

(30) Foreign Application Priority Data
Mar. 3, 2022 (JP) 2022-032332

(51) Int. Cl. G06Q 10/30; G06Q 50/26

(52) U.S. Cl. CPC G06Q 10/30; G06Q 50/26

(57) ABSTRACT

An information processing device according to an aspect of the present disclosure receives a request for a product search from a user terminal, and extracts product information of a product corresponding to the received request from a product database. The product information includes emission information indicating an emission amount of the greenhouse gas of each component constituting the product. Then, the information processing device returns the extracted product information to the user terminal so that the emission information can be output for each component of the product.

### CROSS-REFERENCE TO RELATED APPLICATION

This application claims priority to Japanese Patent Application No. 2022-032332 filed on Mar. 3, 2022, incorporated herein by reference in its entirety.

### BACKGROUND

### 1. Technical Field

The present disclosure relates to an information processing device, an information processing method, and a storage medium storing a program for providing product information.

### 2. Description of Related Art

Japanese Unexamined Patent Application Publication No. 2010-044667 (JP 2010-044667 A) proposes a system for providing an emission amount of greenhouse gas generated by consumption of a product. Specifically, in the system proposed in JP 2010-044667 A, a management server includes a database that stores a correspondence relationship between a cooking method of a product and an emission amount of greenhouse gas when the product is cooked by the cooking method. The management server receives, via a communication network, a request to provide the emission amount of the greenhouse gas related to consumption of each product belonging to a product group listed in a product catalog. The management server derives, based on the database and the cooking method, the emission amount of the greenhouse gas related to consumption of each of the products belonging to the predetermined product group. The management server then provides the derived emission amount via the communication network.

### SUMMARY

The present disclosure provides a technique for visualizing at least a part of factors contributing to a reduction of greenhouse gas emissions achieved by actions to select products.

An information processing device according to a first aspect of the present disclosure includes a control unit configured to: receive a request for a product search from a user terminal; extract product information of a product corresponding to the received request from a product database, the product information including emission information indicating an emission amount of greenhouse gas of each of components constituting the product; and return the extracted product information to the user terminal such that an output of the emission information for each of the components of the product is allowed.

An information processing method according to a second aspect of the present disclosure is an information processing method executed by a computer. The information processing method includes: receiving a request for a product search from a user terminal; extracting product information of a product corresponding to the received request from a product database, the product information including emission information indicating an emission amount of greenhouse gas of each of components constituting the product; and returning the extracted product information to the user terminal such that an output of the emission information for each of the components of the product is allowed.

A storage medium according to a third aspect of the present disclosure stores a program that is a program for causing a computer to execute an information processing method. The information processing method includes: receiving a request for a product search from a user terminal; extracting product information of a product corresponding to the received request from a product database, the product information including emission information indicating an emission amount of greenhouse gas of each of components constituting the product; and returning the extracted product information to the user terminal such that an output of the emission information for each of the components of the product is allowed.

According to the present disclosure, it is possible to visualize at least a part of factors of a reduction of the greenhouse gas emissions achieved by actions to select products.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a scene to which the present disclosure is applied;

FIG. 2 schematically illustrates an example of a hardware configuration of the information processing device according to the embodiment;

FIG. 3 schematically illustrates an example of a software configuration of the information processing device according to the embodiment;

FIG. 4 schematically illustrates an example of a product database according to an embodiment;

FIG. 5 is a flowchart illustrating an example of a processing procedure of the information processing device according to the embodiment;

FIG. 6 schematically illustrates an example of a screen display of product information according to the embodiment;

FIG. 7 schematically illustrates an exemplary screen-display of product information according to the embodiment; and

FIG. 8 schematically illustrates an example of a product database according to a modification.

### DETAILED DESCRIPTION OF EMBODIMENTS

According to the conventional system such as JP-A-2010-044667, it is possible to provide information indicating the emission amount of the greenhouse gas for each product. The user compares the emission amount of greenhouse gas for each product by referring to the information provided. The user can contribute to a reduction in the emission amount of greenhouse gas by selecting a product having a low amount of greenhouse gas emissions based on the comparison result.

However, in the conventional system, information indicating the emission amount of the greenhouse gas is provided on a product-by-product basis. Therefore, even if the user can select a product with a low emission amount, the factor of the low emission amount of the greenhouse gas in the product is opaque. That is, in the conventional system, the factor of the reduction of the greenhouse gas emission by the selection action of the product is not visualized, and it takes time and effort for the user to confirm the factor of the reduction of the greenhouse gas emission.

On the other hand, the information processing device according to the first aspect of the present disclosure includes a control unit configured to execute: receiving a request for a product search from a user terminal; extracting, from a product database, product information of a product corresponding to the received request, the product information including emission information indicating an emission amount of the greenhouse gas of each component constituting the product; and returning the extracted product information to the user terminal so that the emission information can be output for each component of the product.

In the information processing device according to the first aspect of the present disclosure, information indicating an emission amount of a greenhouse gas is provided for each component constituting a product. This allows users to compare the emission amounts of greenhouse gas on a per-component basis between products. In this comparison, since the emission amount of greenhouse gas of the component included in the target product are smaller than those of the other products, one of the factors that reduce the greenhouse gas emissions of the target product can be identified. In other words, the inclusion of such components can be identified as one of the factors for reducing the emission amount of greenhouse gas in the target product. Therefore, according to the information processing device according to the first aspect of the present disclosure, it is possible to visualize at least a portion of the factors of reduction in greenhouse gas emissions by the choice action of the product of the user. As a result, it is possible to reduce the time and effort for the user to confirm the cause.

Hereinafter, an embodiment according to an aspect of the present disclosure (hereinafter, also referred to as “present embodiment”) will be described with reference to the drawings. However, the embodiments described below are merely examples of the present disclosure in all respects. Various modifications or variations may be made without departing from the scope of the present disclosure. In the implementation of the present disclosure, a specific configuration according to the embodiment may be adopted as appropriate. Although the data appearing in the present embodiment is described in a natural language, more specifically, the data is designated by a pseudo language, a command, a parameter, a machine language, or the like that can be recognized by a computer.

### 1 Application Example

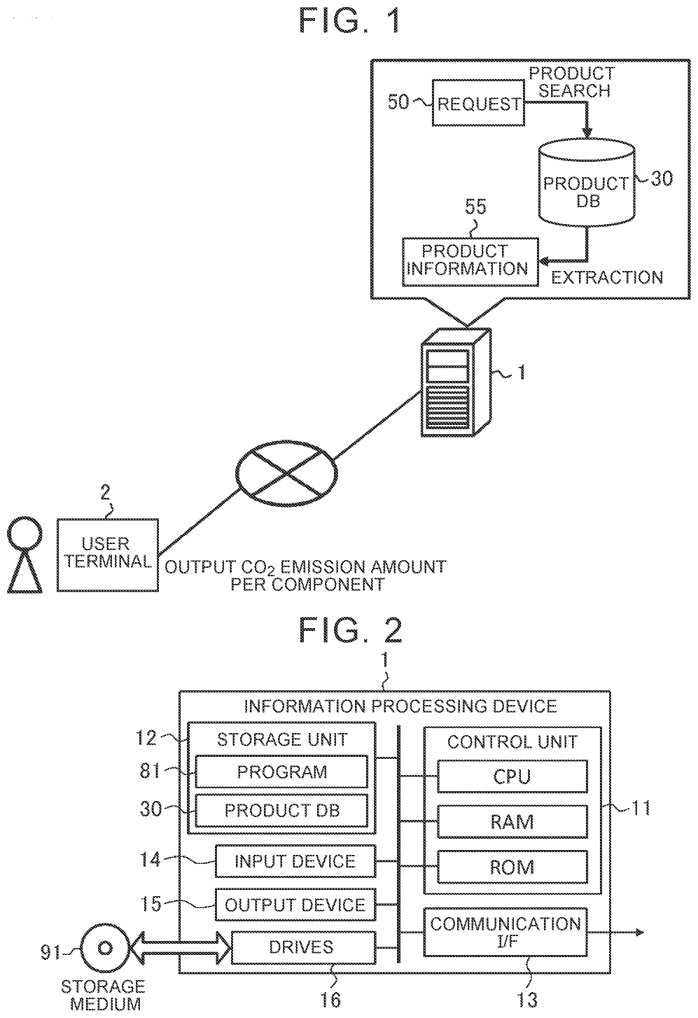

FIG. 1 schematically illustrates an example of a scene to which the present disclosure is applied. The information processing device 1 according to the present embodiment is one or more computers. The one or more computers are configured to execute information processing for providing product information in response to a request from a user.

Specifically, the information processing device 1 according to the present embodiment receives the product search request 50 from the user terminal 2. The information processing device 1 extracts the product information 55 of the product corresponding to the received request 50 from the product database 30. The product information 55 is configured to include emission information indicating an emission amount of the greenhouse gas of each component constituting the product. The information processing device 1 returns the extracted product information 55 to the user terminal 2 so that the emission information can be output for each component of the product. Outputting the emission information on a component-by-component basis may be configured by outputting the emission amount of the greenhouse gas on a component-by-component basis.

As described above, according to the present embodiment, it is possible to provide information (emission information) indicating the emission amount of the greenhouse gas for each component constituting the product. This makes it possible to compare the emission amounts of greenhouse gas by component between products. In this comparison, since the emission amounts of greenhouse gas of the components included in the target product are smaller than those of the other products, one of the factors that reduce the greenhouse gas emissions of the target product can be identified. Therefore, according to the present embodiment, it is possible to visualize at least a portion of the factors of the reduction of greenhouse gas emissions by the choice action of the product of the user. As a result, it is possible to reduce the time and effort for the user to confirm the cause.

### Component of a Product

A product is an article that may be the subject of a business. The product may be any product, such as, for example, food and drink, appliances, etc. The number of articles to be treated as a product is not particularly limited. The number of articles to be treated as a product may be appropriately determined according to the embodiment. As an example, suppose a case where 24 water-filled PET bottles are sold together. In this case, in one example, 24 water-filled PET bottles may be considered as a single product. In another example, one water-filled PET bottle may be regarded as one product, and 24 water-filled PET bottles may be regarded as 24 products.

The component of the product is an article constituting at least a part of the product. The unit of the component may be appropriately determined according to the embodiment. The component may be an article that can be grasped by itself. As an example, if the product is water enclosed in a labeled PET bottle container, the components of product may be water, PET bottle containers, and labels.

For example, a plurality of articles, such as 1 dozen, 24 pieces, or the like, may be packaged together and sold. Also, for example, one product, such as an electric appliance, may be packaged and sold together with accessories, instructions, and the like. When packaging is used as in these examples, each component of the product of manufacture may include the packaging. The packaging material may be, for example, a paper material, a corrugated board material, a vinyl material, a polystyrene foam material, or the like. If more than one type of packaging is used, each packaging may be handled individually or at least partially together. This makes it possible to visualize the emission amount of greenhouse gas caused by the packaging material.

### Request

The request 50 (query) includes a condition for searching for a product. The search conditions may be specified in any manner, including known ways. As an example, the search condition may be specified by a character string (for example, a product name, a content, or the like), a category, an attribute (for example, a price range, a size, a color scheme, a material, a brand, an evaluation value, or the like), or the like. The information processing device 1 is configured to extract the product information 55 of the product corresponding to the condition specified by the request 50 from the product database 30 with reference to the product database 30. Any method including a known method may be employed as the configuration and search method of the product database 30.

### Greenhouse Gas

As a typical example, the greenhouse gas is carbon dioxide. In addition, the greenhouse gas may include a greenhouse gas such as methane, dinitrogen monoxide, fluorocarbons, sulfur hexafluoride, and sulfur trifluoride. As shown in FIG. 1, in the present embodiment, for convenience of explanation, carbon dioxide (CO₂) is adopted as an exemplary greenhouse gas. However, the greenhouse gas of which emission amount is to be output may not be limited to carbon dioxide, and may be appropriately selected according to the embodiment. The greenhouse gas of which emission amount is to be output may be composed of one or more kinds of gases. In one example, the greenhouse gas of interest may be comprised of carbon dioxide, methane, dinitrogen monoxide, fluorocarbons, sulfur hexafluoride, sulfur trifluoride, or combinations thereof.

The emission amounts of greenhouse gases of each component may be measured as appropriate according to the embodiment. In one example, the emission amount of greenhouse gas of each component may be calculated by measuring the amount of greenhouse gas emitted in the process of obtaining each component such as procurement, production, etc.

### Product Information

The product information stored in the product database 30 includes emission information indicating an emission amount of the greenhouse gas of each component constituting the product. The data format and configuration of the product information are not particularly limited, and may be appropriately determined according to the embodiment. The product information may include information such as a description of a product, a price, a product image, and the like in addition to the emission information.

In the user terminal 2, the extracted product information 55 of each product may be output in any format including, for example, a list format, a table format, and other known formats. Further, the output of the product information 55 including the emission information may be executed in any format including, for example, a known format such as an image display or an audio output. Emission information includes the emission amounts of greenhouse gases for each component. The data format and configuration of the emission information are not particularly limited, and may be appropriately determined according to the embodiment.

### Target Article to Recycling

Each component of the product may include a target article to be recycled (i.e., a recyclable article). The target article to be recycled may be appropriately determined according to the embodiment. The target articles to be recycled may be, for example, paper, aluminum, copper, iron, glass, PET bottles, batteries, and the like.

In a case where the component of the product includes the target article for recycling, the emission information of the product may include the first comparison information. The first comparison information indicates the difference between the emission amount of greenhouse gas when the target article is recycled and the emission amount of greenhouse gas when the target article is not recycled. In addition, the output of the emission information may include an output of the first comparison information. This makes it possible to visualize the contribution of recycling to the reduction of the emission amount of greenhouse gas.

According to the first comparison information, the user can grasp the difference in the emission amount of the greenhouse gas in the case of recycling and in the case of not recycling. The data format of the first comparison information is not particularly limited, and may be appropriately determined according to the embodiment. In an example, the first comparison information may be configured by information indicating an emission amount of the greenhouse gas of the target article and a reduction amount of the emission of the greenhouse gas when the target article is recycled. In another example, the first comparison information may be configured by information indicating an emission amount of the greenhouse gas of the target article in a case where the target article is recycled, and an emission amount of the greenhouse gas of the target article in a case where the target article is not recycled.

By outputting the first comparison information, the user can grasp the difference between the emission amount of greenhouse gas when recycled and when not recycled. The form of output of the first comparison information is not particularly limited, and may be appropriately determined according to the embodiment. In an example, outputting the first comparison information may be configured by outputting an emission amount of the greenhouse gas of the target article and a reduction amount due to recycling. In another example, outputting the first comparison information may be configured by outputting the emission amount of greenhouse gas of the target article when recycled and when not recycled. When any example of the above-described data format of the first comparison information is adopted, any example of the output format may be adopted.

### Recycled Article

Each component of the product may include a recycled article produced by the recycled material. Recycled materials are materials obtained by recycling. The type and usage of the recycled material may be appropriately determined according to the embodiment. It should be noted that generating the components of the product by the recycled material may include using the recycled material for at least a part of the components (recycled articles) of the product.

When a recycled article is included in a component of the product, the emission information of the product may include second comparison information. The second comparison information shows the difference between the emission amount of greenhouse gas of the recycled article and the emission amount of greenhouse gas when the recycled article was replaced by the virgin article produced by the virgin material (i.e., no recycled article was used). In addition, the output of the emission information may include an output of the second comparison information. This makes it possible to visualize the contribution to the reduction of the emission amount of greenhouse gas by selecting products including recycled article. The virgin material is a material obtained from a new material. The replacement of the virgin article corresponds to the use of the virgin article as the same component as the recycled article in the target product.

The second comparison information allows the user to ascertain the difference in the emission amounts of greenhouse gas when recycled articles are used and when recycled articles are not used (i.e., virgin articles are used). The data format of the second comparison information is not particularly limited, and may be appropriately determined according to the embodiment. In one example, the second comparison information may be comprised of information indicating the emission amount of greenhouse gas of the recycled article and the amount of greenhouse gas emissions reduced by replacing the virgin article with the recycled article (i.e., using the recycled article without using the virgin article for the product). In another example, the second comparison information may be configured by information indicating an emission amount of the greenhouse gas of the recycled article and an emission amount of the greenhouse gas of the virgin article.

The output of the second comparison information allows the user to grasp the difference in the emission amount of the greenhouse gas when the recycled article is used and when the recycled article is not used. The form of output of the second comparison information is not particularly limited, and may be appropriately determined according to the embodiment. In one example, outputting the second comparison information may be configured by outputting an emission amount of greenhouse gas of the recycled article and an amount of reduction due to the use of the recycled article. In another example, outputting the second comparison information may be configured by outputting the greenhouse gas emission amount of the recycled article and the greenhouse gas emission amount of the virgin article. In the case where any example of the data format of the second comparison information is adopted, any example of the output format may be adopted.

Comparison with Other Products

In the product database 30, the emission amounts of greenhouse gases may be compared between corresponding components of the same type of product. As a result of this comparison, a product including a component that emits more greenhouse gases than other products may be provided with flag information indicating the fact.

That is, if the emission amount of greenhouse gas of the target component included in the product is larger than the emission amount of greenhouse gas of the same component included in another product of the same type as the product, the emission information may include flag information. Flag information indicates that the emission amounts of greenhouse gas of the components of interest are higher than the emission amounts of greenhouse gas of the same components in other products. In addition, the output of the emission information may include an output of the flag information. This makes it possible to visualize whether or not the product contains components that emit more greenhouse gases than other products.

The same component included in another product is the same type of component as the target component included in the target product. For example, if the component of interest is a PET bottle container, the same component is a PET bottle container used in other products.

The criteria to be recognized as being larger than other products may be appropriately determined according to the embodiment. In one example, more than other products may be products other than the fewest products, more than a threshold value from the fewest other products, or the greatest. The threshold value may be set as appropriate.

The output of the flag information allows the user to recognize that the emission amount of greenhouse gas of the target component is larger than that of other products. The mode of outputting the flag information is not particularly limited, and may be appropriately selected according to the embodiment. The output of the flag information may be configured by, for example, changing a display form (for example, changing a character type, changing a color of a character, or the like), outputting a sentence indicating that the number of items is larger than that of other products, or the like.

### User Terminal

The user terminal 2 is one or more computers used by the user. The user terminal 2 may be a desktop PC (Personal Computer), a mobile telephone including a smart phone, a tablet PC, a general-purpose computer, or the like, in addition to a computer specifically designed for a provided service.

As illustrated in FIG. 1, the information processing device 1 and the user terminal 2 may be connected to each other via a network. The type of network may be selected from among, for example, the Internet, wireless communications networks, mobile communications networks, telephone networks, dedicated networks, etc., as appropriate. Any method including a known method may be adopted for data communication between the information processing device 1 and the user terminal 2.

### Two Configuration Examples

### Example of the Hardware Configuration

FIG. 2 schematically illustrates an example of a hardware configuration of the information processing device 1 according to the present embodiment. As illustrated in FIG. 2, the information processing device 1 according to the present embodiment is a computer in which the control unit 11, the storage unit 12, the communication interface 13, the input device 14, the output device 15, and the drive 16 are electrically connected to each other.

The control unit 11 includes a hardware processor such as Central Processing Unit (CPU), Random Access Memory (RAM), Read Only Memory (ROM), and the like. The control unit 11 is configured to execute information processing based on a program and various data. The control unit 11(CPU) is an exemplary processor resource.

The storage unit 12 includes, for example, a hard disk drive, a solid state drive, and the like. The storage unit 12 is an example of a memory resource. In the present embodiment, the storage unit 12 stores various kinds of information such as the program 81 and the product database 30.

The program 81 is a program for causing the information processing device 1 to execute information processing (FIG. 5 described later) for providing product information in response to a request from a user. The program 81 includes a series of instructions for the information processing. The product database 30 stores product information in a searchable format.

The communication interface 13 is, for example, a wired Local Area Network (LAN) module, a radio LAN module, or the like. The communication interface 13 is an interface for performing wired or wireless communication via a network. The information processing device 1 can perform data communication with another computer (for example, the user terminal 2) using the communication interface 13.

The input device 14 is a device such as a mouse or a keyboard for performing input. The output device 15 is a device for outputting, for example, a display, a speaker, or the like. The operator can operate the information processing device 1 by using the input device 14 and the output device 15. For example, the input device 14 and the output device 15 may be integrally formed by a touch panel display or the like.

The drive 16 is a device for reading various kinds of information such as a program stored in the storage medium 91. The storage medium 91 may store at least one of the program 81 and the product database 30. The storage medium 91 is a medium that stores information of the program or the like by electrical, magnetic, optical, mechanical or chemical action so that a computer, other device, machine, or the like can read various kinds of information such as a stored program. The information processing device 1 may acquire at least one of the program 81 and the product database 30 from the storage medium 91.

FIG. 2 illustrates a disk-type storage medium such as a CD, DVD as an exemplary storage medium 91. However, the type of the storage medium 91 is not limited to the disk type, and may be other than the disk type. As a storage medium other than the disk type, for example, a semiconductor memory such as a flash memory can be exemplified. The type of the drive 16 may be appropriately selected according to the type of the storage medium 91.

Regarding the specific hardware configuration of the information processing device 1, it is possible to omit, replace, and add components as appropriate depending on the embodiment. For example, the control unit 11 may include a plurality of hardware processors. Hardware processors may be comprised of microprocessors, field-programmable gate array (FPGA), Graphics Processing Unit (GPU), etc. At least one of the communication interface 13, the input device 14, the output device 15, and the drive 16 may be omitted.

The information processing device 1 may further include an external interface for connecting to an external apparatus. The external interfaces are, for example, Universal Serial Bus (USB) ports, dedicated ports, and the like. The type and number of external interfaces may be appropriately determined according to the type and number of external devices to be connected. The information processing device 1 may be connected to another computer via an external interface. The information processing device 1 may be connected to an external storage device via an external interface. In this case, the external storage device may store at least one of the program 81 and the product database 30. The information processing device 1 may acquire at least one of the program 81 and the product database 30 from an external storage device.

The information processing device 1 may include a plurality of computers. In this case, the hardware configurations of the computers may or may not be identical. The information processing device 1 may be configured by any computer capable of executing information processing. The information processing device 1 may be a general-purpose server device, a general-purpose Personal Computer (PC, or the like, in addition to a computer designed for service-dedicated services to be provided.

### Software Configuration Example

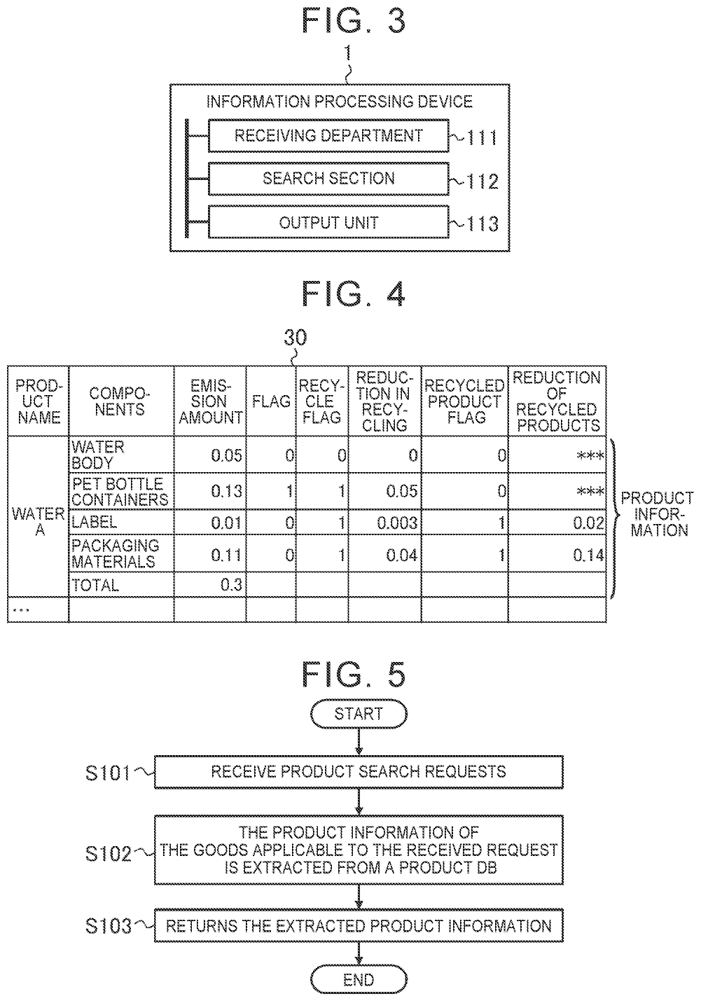

FIG. 3 schematically illustrates an example of a software configuration of the information processing device 1 according to the present embodiment. The control unit 11 of the information processing device 1 develops the program 81 stored in the storage unit 12 into a RAM. Then, the control unit 11 executes the instruction included in the program 81 loaded in RAM by CPU. Thus, as illustrated in FIG. 3, the information processing device 1 according to the present embodiment operates as a computer including the receiving unit 111, the search unit 112, and the output unit 113 as software modules. That is, in the present embodiment, the software modules of the information processing device 1 are realized by the control unit 11(CPU).

The receiving unit 111 is configured to receive the product search request 50 from the user terminal 2. The search unit 112 is configured to extract, from the product database 30, product information 55 of the product corresponding to the received request 50, and product information 55 including emission information indicating the emission amount of the greenhouse gas of each component constituting the product. The output unit 113 is configured to return the extracted product information 55 to the user terminal 2 so that the emission information can be output for each component of the product.

In the present embodiment, the software modules of the information processing device 1 are all realized by a general-purpose CPU. However, some or all of the software modules may be implemented by one or more dedicated processors. Each of the above modules may be implemented as a hardware module. Regarding the software configuration of the information processing device 1, omission, replacement, and addition of modules may be appropriately performed according to the embodiment.

### Product Database

FIG. 4 schematically illustrates an example of the product database 30 according to the present embodiment. In the example of FIG. 4, the product database 30 has a data structure in a table format. The product data illustrated in FIG. 4 corresponds to the product information of one product. The product data includes fields for storing a product name, a component, an emission amount, a flag, a recycle flag, a recycle reduction amount, a recycle product flag, and a recycle product reduction amount.

In the product name field, information indicating the name of the product is stored. In the component field, information indicating each component constituting a product is stored. The emission amount field contains information indicating the emission amount of greenhouse gas of the components of interest. The “Total” record contains the total emission amount of greenhouse gas for each component.

The flag field contains information indicating whether the emission amount of greenhouse gas of the target component are higher or lower than the emission amount of the same component included in other products. “1” in the flag field indicates that the emission amounts of greenhouse gas of the components of interest are higher than the emission amount of greenhouse gas of the same components in other products. A “0” in the flag field indicates that the emission amounts of greenhouse gas of the components of interest are lower than the emission amount of greenhouse gas of the same components in other products.

In the recycle flag field, information indicating whether or not the target component is the target article for recycling is stored. A “1” in the recycle flag field indicates that the target component is the target article for recycling. A “0” in the recycle flag field indicates that the target component is not the target article for recycling. The Recycling Reduction Amount field stores information indicating the amount of reduction in greenhouse gas emissions when the target article is recycled.

In the recycled article flag field, information indicating whether or not the target component is a recycled article generated by the recycled material is stored. A “1” in the recycled article flag field indicates that the component of interest is a recycled article. A “0” in the recycled item flag field indicates that the component of interest is not a recycled article (i.e., the component of interest is a virgin article). The Recycled Goods Reduction Amount field stores information indicating the amount of reduction in greenhouse gas emissions due to the use of recycled articles (i.e., replacement of virgin article with recycled articles).

In the example of FIG. 4, records (row data) are provided according to the respective components with respect to fields subsequent to the components. In each record, various kinds of information of each component are stored. The information stored in each field from the emission amount to the recycled product reduction amount is an example of the emission information. The information stored in the flag field is an example of the flag information.

The information stored in the emission amount field and the recycle reduction amount field is an example of the first comparison information. That is, in the example of FIG. 4, the first comparison information includes information indicating the emission amount of greenhouse gas of the target article in a case where the target article is not recycled, and the amount of reduction in greenhouse gas emissions in a case where the target article is recycled.

Further, the information stored in the emission amount field and the recycled product reduction amount field is an example of the second comparison information. That is, in the example of FIG. 4, the second comparison information includes information indicating the emission amount of greenhouse gas of the recycled article and the amount of reduction in greenhouse gas emissions caused by the replacement of the virgin article with the recycled article.

In the example of FIG. 4, the following conditions are assumed as a specific example of the product. That is, the product “Water A” is equipped with water bodies, PET bottle containers, labels, and packaging materials as components. Among these components, PET bottle containers, labels, and packaging materials are target articles to be recycled. Labels and packaging are recycled articles, while water bodies and PET bottle containers are virgin articles. The emission amount of greenhouse gas from PET bottle containers in Water A is higher than the amount of greenhouse gas emissions from the same components (PET bottle containers) contained in other products (water) of the same type as Water A. However, these conditions are merely specific examples for convenience of explanation, and do not limit the contents of the present disclosure.

Note that the data format of the product database 30 is not limited to the example illustrated in FIG. 4. As long as the product database 30 stores the product information in a searchable state, the data format of the product database 30 is not particularly limited, and may be appropriately determined according to the embodiment. Further, the product information stored in the product database 30 may include information other than the information illustrated in FIG. 4. The product information may include, for example, information such as a description of the product, a product image, a price, and other attributes.

In the example of FIG. 4, in the flag field, the recycle flag field, and the recycled product flag field, the flag is expressed as “1”, and the flag is not expressed as “0”. However, the expression format of the flag is not limited to such an example, and may be appropriately determined according to the embodiment.

### 3 Operation Example

FIG. 5 is a flowchart illustrating an example of a processing procedure of the information processing device 1 according to the present embodiment. The processing procedure described below is an example of an information processing method according to an aspect of the present disclosure. However, the processing procedure described below is merely an example, and each step may be changed as much as possible. Further, the following processing procedures may be appropriately omitted, replaced, and added in accordance with the embodiment.

### S101 of Steps

In the step-wise S101, the control unit 11 operates as the receiving unit 111 and receives the product search request 50 from the user terminal 2.

As a method of inputting the condition of the product search in the user terminal 2 and a method of transmitting the request 50 from the user terminal 2 to the information processing device 1, any method including a known method may be employed. In an example, the user terminal 2 may accept designation of a search condition via an input device. The search condition may be specified by, for example, a character string, a category, an attribute, or the like. The user terminal 2 may transmit the request 50 including the designated search condition to the information processing device 1 via the network using the communication interface. Upon receiving the request 50 from the user terminal 2, the control unit 11 advances the process to the following step S102.

### S102 of Steps

In S102 of steps, the control unit 11 operates as the search unit 112. The control unit 11 refers to the product database 30 and extracts the product information 55 of the product corresponding to the condition specified by the request 50 from the product database 30.

The extraction method (search method) of the product information 55 in the product database 30 may be appropriately determined in accordance with the data format or the like of the product database 30. As the extraction method, any method including a known method may be employed. In an example, in a case where the product name is designated as the search condition, the control unit 11 may extract the product information 55 by referring to the value of the product name field and searching the product data storing the value corresponding to the designated condition. As described above, the product data may store other information such as a description of the product, a price, and the like, and the control unit 11 may extract the product information 55 based on the other information. When the product information 55 of the product corresponding to the request 50 is extracted, the control unit 11 advances the process to the following step S103.

### S103 of Steps

In S103 of steps, the control unit 11 operates as the output unit 113. The control unit 11 returns the extracted product information 55 to the user terminal 2 so that the emission information can be output for each component of the product. In response to this, the user terminal 2 receives the product information 55 and outputs the received product information 55. In an example, the user terminal 2 includes an output device such as a display, and outputs the product information 55 to the output device. However, the output destination of the product information 55 is not limited to such an example, and may be appropriately determined according to the embodiment.

As a method of returning the product information 55 to the user terminal 2, any method including a known method may be employed. In the present embodiment, the control unit 11 may transmit the product information 55 of the extracted product to the user terminal 2 via the network using the communication interface 13. In the user terminal 2, the product information 55 may be output in any format including, for example, a known format such as an image display or an audio output. The output method and the output form may be appropriately determined according to the embodiment.

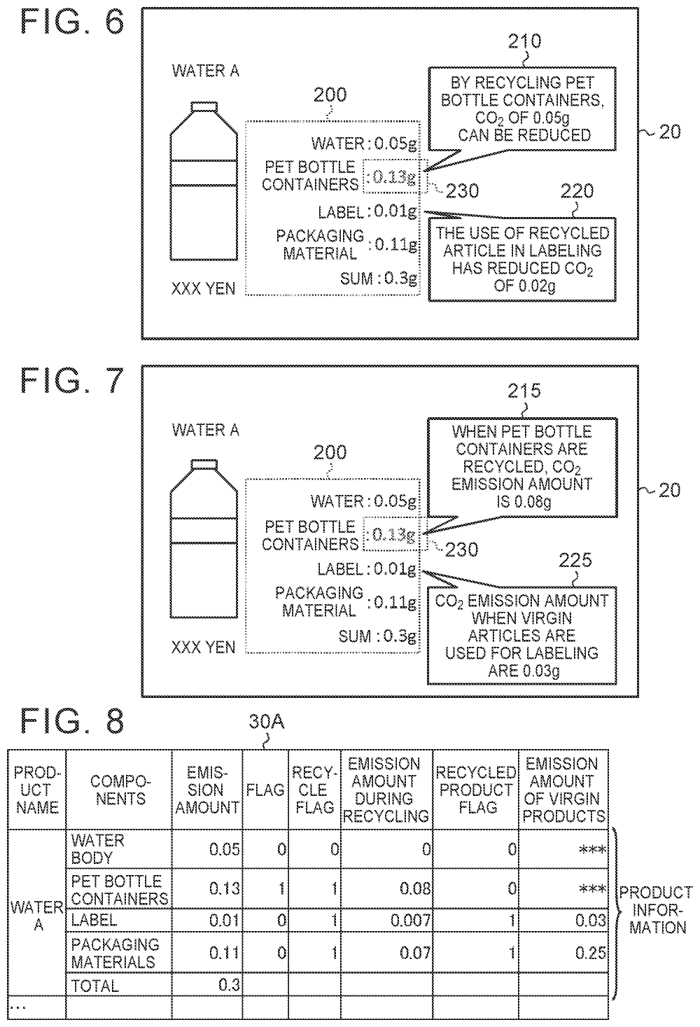

FIG. 6 schematically illustrates an example of an output form (screen display) of the product information 55 in the user terminal 2 according to the present embodiment. In the example of FIG. 6, it is assumed that the product information 55 of “water A” in FIG. 4 is output by a screen display on the output device 20 (display) of the user terminal 2. The output-screen of the product information 55 may be generated by a known method such as Hyper Text Markup Language (HTML), Extensible Markup Language (XML).

In an example of this screen display, the value of the emission amount field of the product information 55 is displayed in the region 200, so that the emission amount of the greenhouse gas is output for each component. In the example of FIG. 6, the “water A” component includes packaging. The emission amounts of greenhouse gas of the packaging material are displayed in region 200. Note that a plurality of articles may be sold together as a single product. In this case, in one example, the emission amount of greenhouse gas of each component may be output in individual product units and/or product units (i.e., the sum of a plurality of products). It may be specified by the user whether to display on an individual item basis or on a product basis (in an example, the display form may be switchable on the screen according to an instruction from the user).

In the balloon 210, the value of the recycle reduction amount field of the product information 55 is displayed. As a result, the amount of reduction in the greenhouse gas caused by recycling of the target article to be recycled is output (in the example of FIG. 6, the PET bottle container). The output of the information in the region 200 and the balloon 210 is an example of the output of the first comparison information. The output of the information in region 200 and blow-off 210 visualizes the contribution to the reduction of the emission amount of greenhouse gas due to recycling.

In the blow-out 220, the value of the recycled product reduction amount field of the product information 55 is displayed. As a result, the amount of reduction caused by the use of the recycled article is output (in the example of FIG. 6, the label). The output of the information in the region 200 and the balloon 220 is an example of the output of the second comparison information. The output of the information in region 200 and balloon 220 visualizes the contribution to reducing the emission amount of greenhouse gas by selecting products including recycled articles.

Region 200 includes a region 230 for outputting information indicative of the emission amount of greenhouse gas of the PET bottle container. In the example of FIG. 4, it is assumed that the emission amount of greenhouse gas of PET bottle containers among the components of “water A” are larger than the emission amount of greenhouse gas of the same components included in other products of the same type. That is, in the record of the PET bottle container, the value of the flag field is “1”. Accordingly, in the region 230, the emission amount of the greenhouse gas of the PET bottle container is output in a display form different from the other components (the water body, the label, and the packaging material). The output of the information in the region 230 is an example of the output of the flag information.

In the example of FIG. 4, as a different display form, the emission amount of the PET bottle container is displayed in a color scheme and a character type different from the display of the emission amount of the other components. However, the different display form may not be limited to such an example as long as it is possible to distinguish between the components having a larger emission amount of greenhouse gas than other products and the components not.

FIG. 7 schematically illustrates another example of an output form (screen display) of the product information 55 in the user terminal 2 according to the present embodiment. In the example of FIG. 7, each of the blowouts (210, 220) to which the comparison information is output is replaced with each of the balloons (215, 225) that adopts a different output form. Except for these points, the screen shown in FIG. 7 is configured similarly to FIG. 6.

In the balloon 215, the emission amount of greenhouse gas emitted from the target article in the case of recycling is output (in the example of FIG. 7, the PET bottle container). The emission amount of greenhouse gas from recycling may be calculated by subtracting the value in the Reduced Recycle Field from the value in the emission amount Field. This calculation process may be executed by the information processing device 1 or may be executed by the user terminal 2. On the other hand, the region 200 outputs the greenhouse gas emission amount of the target article in the case of not being recycled. The output of the information in the region 200 and the balloon 215 is another example of the output of the first comparison information. The output of the information in region 200 and balloon 215 visualizes the contribution to the reduction of the emission amount of greenhouse gas due to recycling.

In the blow-out 225, the emission amount of the greenhouse gas of the virgin article is output (in the example of FIG. 7, the label). The emission amount of greenhouse gases when virgin articles are used may be calculated by adding the value of the Reduced Recycled Products field to the value of the Emission Amount field. This calculation process may be executed by the information processing device 1 or may be executed by the user terminal 2. On the other hand, the region 200 outputs the emission amount of the greenhouse gas of the recycled article. The output of the information in the region 200 and the balloon 225 is another example of the output of the second comparison information. The output of the information in region 200 and balloon 225 visualizes the contribution to reducing the emission amount of greenhouse gas by selecting products including recycled articles.

The output of the information illustrated in FIGS. 6 and 7 is an example of outputting the emission information for each component of the product. However, the output forms illustrated in FIGS. 6 and 7 are merely examples for convenience of explanation, and the output forms (the screen design, the order of audio output, and the like) of the product information 55 may not be limited to such examples.

In another example, one of the first comparison information and the second comparison information may be output in the form of FIG. 6, and the other may be output in the form of FIG. 7. When a plurality of target articles to be recycled are included, as shown in FIGS. 6 and 7, first comparison information of each target article may be individually output. Alternatively, at least some of the first comparison information of the target article may be output at a time. When a plurality of recycled articles are included, the second comparison information of each recycled article may be output individually, or at least a part of the second comparison information of the recycled articles may be output at once.

When the product information 55 includes the first comparison information, the first comparison information may be output according to an instruction from the user (for example, the cursor is placed on the name of the component on the screen of FIG. 6 or FIG. 7), or may be output without depending on the instruction from the user. When the product information 55 includes the second comparison information, the second comparison information may be output according to an instruction from the user or may be output without depending on an instruction from the user. The mode in which the first comparison information and the second comparison information are output is not limited to the balloon, and may be appropriately selected according to the embodiment. Further, the output of the flag information is not limited to the change of the display form illustrated in FIGS. 6 and 7. In another example, the flag information may be output as a sentence indicating that the number of products is larger than that of other products.

When the product information 55 is returned to the user terminal 2, the control unit 11 ends the processing procedure according to this operation example. Note that the control unit 11 may wait until receiving the request 50 from the user terminal 2 to execute the process of the step S101. Then, the control unit 11 may execute the process of step S102 and step S103 in response to receiving the request 50 from the user terminal 2. Accordingly, the control unit 11 may repeatedly execute the process of the step S103 from the step S101. That is, the information processing device 1 may be configured to continuously execute information processing for returning the product information 55 to the request 50 from the user.

### Features

The information processing device 1 according to the present embodiment can provide the product information 55 including the emission information indicating the emission amount of the greenhouse gases for each component of the product by the process of the step S101 to the step S103. Accordingly, based on the information provided (FIG. 6 and FIG. 7 are examples thereof), the user can compare the emission amounts of the greenhouse gases between the respective products on a component basis. In this comparison, since the emission amount of greenhouse gas of the components included in the target product is smaller than that of the other products, the user can identify one of the factors that reduce the amount of greenhouse gas emissions in the target product. Therefore, according to this embodiment, it is possible to visualize at least a portion of the factors of the reduction of the emission amount of greenhouse gas by the choice behavior of products. As a result, it is possible to reduce the time and effort for the user to confirm the cause.

### 4 Modification

While embodiments of the present disclosure have been described in detail above, the foregoing description is merely illustrative of the present disclosure in all respects. Needless to say, various modifications and variations can be made without departing from the scope of the present disclosure. For example, the following changes are possible. In the following description, the same reference numerals are used for the same components as those in the above-described embodiment, and description of the same components as those in the above-described embodiment is omitted as appropriate. The following modifications can be combined as appropriate.

4.1

In the above-described embodiment, the product database 30 is stored in a storage device (the storage unit 12, the external storage device, the storage medium 91, and the like) of the information processing device 1. However, the storage destination of the product database 30 is not limited to such an example. In another example, the product database 30 may be stored in another computer, such as a network server. In this case, in the above-described step S102, the control unit 11 may access the product database 30 by connecting to another computer via a network or the like to extract the product information 55 from the product database 30 (the product information 55 may be extracted to another computer).

4.2

In the example of FIG. 4 of the above-described embodiment, the first comparison information is constituted by information indicating the emission amount of greenhouse gas of the target article in the case of not recycling, and the amount of reduction in the amount of greenhouse gas emission in the case of recycling. In addition, the second comparison information includes information indicating the emission amount of greenhouse gas of recycled articles and the amount of reduction in greenhouse gas emissions due to the use of recycled articles. However, the first comparison information and the second comparison information may not be limited to such an example.

FIG. 8 schematically illustrates an example of the product database 30A according to the present modification. In the example of FIG. 8, the product data includes a recycle-time emission field in place of the recycle reduction field of FIG. 4, and a virgin product emission amount field in place of the recycle reduction field.

In the recycling emission amount field, information indicating the emission amount of the greenhouse gas of the target article in the case where the target article is recycled is stored. The information stored in the emission amount field and the recycling-time emission amount field is another example of the first comparison information. That is, in the example of FIG. 8, the first comparison information is constituted by information indicating the emission amount of greenhouse gas of the target article when the target article is recycled and the amount of greenhouse gas emissions of the target article when the target article is not recycled.

In the virgin product emission amount field, information indicating an emission amount of a greenhouse gas of a virgin article (that is, in a case where a virgin product is used as a component that is a recycled article) is stored. The information stored in the emission amount field and the virgin product emission amount field is another example of the second comparison information. That is, in the example of FIG. 8, the second comparison information is constituted by information indicating the emission amount of the greenhouse gas of the recycled article and the emission amount of the greenhouse gas of the virgin article.

Except for these points, the product database 30A according to the present modification may be configured similarly to the product database 30 according to the above-described embodiment. In the above embodiment, the product database 30 may be replaced with the product database 30A according to the present modification. Similar to the above-described embodiment, the control unit 11 may receive the request 50 from the user terminal 2 by the step S101. In S102 of steps, the control unit 11 may extract the product information 55 of the product corresponding to the request 50 from the product database 30A. Then, the control unit 11 may return the extracted product information 55 to the user terminal 2 by the step S103.

In the user terminal 2, the first comparison information may be output as appropriate. In an example, the first comparison information may be output in the form of FIG. 7 by displaying the value of the recycling emission amount field. In another example, the reduction amount of the greenhouse gas by recycling the target article may be calculated by subtracting the value of the recycling-time emission amount field from the value of the emission amount field. This calculation process may be executed by the information processing device 1 or may be executed by the user terminal 2. The first comparison information may be output in the form of FIG. 6 by displaying the calculated value of the reduction amount.

In the user terminal 2, the second comparison information may also be output as appropriate. In an example, the second comparison information may be output in the form of FIG. 7 by displaying the value of the virgin product emission amount field. In another example, the reduction amount due to the use of the recycled article may be calculated by subtracting the value of the emission amount field from the value of the virgin article emission amount field. This calculation process may be executed by the information processing device 1 or may be executed by the user terminal 2. The second comparison information may be output in the form of FIG. 6 by displaying the calculated value of the reduction amount.

According to this modification, it is possible to visualize the contribution to the reduction of the emission amount of the greenhouse gas due to the recycling by the first comparison information. In addition, the second comparison information can visualize the contribution to the reduction of the emission amount of the greenhouse gas by selecting a product including a recycled article.

Note that the configuration of the first comparison information and the second comparison information is not limited to an example of FIG. 4 (embodiment) and FIG. 8 (modification example), and may be appropriately determined according to the embodiment. In another example, one of the first comparison information and the second comparison information may be configured in the form of FIG. 4, and the other may be configured in the form of FIG. 8. In yet another example, the first comparison information may be configured to indicate an increase in greenhouse gas emissions when not recycled, instead of a reduction in greenhouse gas emissions when recycled. The second comparison information may be configured to indicate an increase in greenhouse gas emissions when the virgin product is included, instead of a reduction in greenhouse gas emissions due to the inclusion of the recycled article. The same applies to the output form.

4.3

In the above-described embodiment, the packaging material may be omitted from each component of the product. In this case, the components of the present disclosure relating to the packaging material may be omitted.

In the above-described embodiment, the recycled target article may be omitted from the attributes of the respective components of the product. In this case, the components of the present disclosure relating to the target article to be recycled may be omitted. First comparison information may be omitted from the product information.

In the above-described embodiment, the recycled article may be omitted from the attributes of the respective components of the product. In this case, the components of the present disclosure relating to the recycled article may be omitted. The second comparison information may be omitted from the product information.

In the above-described embodiment, the flag information may be omitted from the emission information. In this case, each component of the present disclosure related to the flag information may be omitted.

### Supplement

The processing and units described in the present disclosure can be freely combined and implemented as long as there is no technical contradiction.

Further, the processes described as being executed by one device may be shared and executed by a plurality of devices. Alternatively, the processes described as being performed by different devices may be performed by a single device. In the computer system, the hardware configuration for implementing each function can be flexibly changed.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, HDD, etc.) and an optical disc (compact disc read-only memory (CD-ROM), digital versatile disc (DVD), Blu-ray disc, etc.), a ROM, a RAM, an EPROM, an electrically erasable programmable read only memory (EEPROM), a magnetic card, a flash memory, an optical card, and any type of medium suitable for storing electronic commands.

What is claimed is:

1. An information processing device comprising a control unit configured to:
receive a request for a product search from a user terminal;
extract product information of a product corresponding to the received request from a product database, the product information including emission information indicating an emission amount of greenhouse gas of each of components constituting the product; and
return the extracted product information to the user terminal such that an output of the emission information for each of the components of the product is allowed.

2. The information processing device according to claim 1, wherein each of the components includes a packaging material for the product.

3. The information processing device according to claim 1, wherein:
when each of the components of the product includes a target article of recycling,
the emission information of the product includes first comparison information indicating a difference between an emission amount of the greenhouse gas when the target article is recycled and an emission amount of the greenhouse gas when the target article is not recycled; and
the output of the emission information includes an output of the first comparison information.

4. The information processing device according to claim 3, wherein the first comparison information is composed of information indicating the emission amount of the greenhouse gas of the target article and a reduction amount in an emission of the greenhouse gas when the target article is recycled.

5. The information processing device according to claim 3, wherein the first comparison information is composed of information indicating the emission amount of the greenhouse gas of the target article when the target article is recycled, and the emission amount of the greenhouse gas of the target article when the target article is not recycled.

6. The information processing device according to claim 1, wherein:
when each of the components of the product includes a recycled article produced using a recycled material,
the emission information of the product includes second comparison information indicating a difference between an emission amount of the greenhouse gas of the recycled article and an emission amount of the greenhouse gas when the recycled article is replaced with a virgin article produced using a virgin material; and
the output of the emission information includes an output of the second comparison information.

7. The information processing device according to claim 6, wherein the second comparison information is composed of information indicating the emission amount of the greenhouse gas of the recycled article and a reduction amount in an emission of the greenhouse gas achieved by replacing the virgin article with the recycled article.

8. The information processing device according to claim 6, wherein the second comparison information is composed of information indicating the emission amount of the greenhouse gas of the recycled article and the emission amount of the greenhouse gas of the virgin article.

9. The information processing device according to claim 1, wherein:
when an emission amount of the greenhouse gas of a target component included in the product is larger than an emission amount of the greenhouse gas of the same component included in another product of the same kind as the product,
the emission information includes flag information indicating that the emission amount of the greenhouse gas of the target component is larger than the emission amount of the greenhouse gas of the same component included in the other product; and
the output of the emission information includes an output of the flag information.

10. An information processing method executed by a computer, the information processing method comprising:
receiving a request for a product search from a user terminal;
extracting product information of a product corresponding to the received request from a product database, the product information including emission information indicating an emission amount of greenhouse gas of each of components constituting the product; and
returning the extracted product information to the user terminal such that an output of the emission information for each of the components of the product is allowed.

11. The information processing method according to claim 10, wherein each of the components includes a packaging material for the product.

12. The information processing method according to claim 10, wherein:
when each of the components of the product includes a target article of recycling,
the emission information of the product includes first comparison information indicating a difference between an emission amount of the greenhouse gas when the target article is recycled and an emission amount of the greenhouse gas when the target article is not recycled; and
the output of the emission information includes an output of the first comparison information.

13. The information processing method according to claim 12, wherein the first comparison information is composed of information indicating the emission amount of the greenhouse gas of the target article and a reduction amount in an emission of the greenhouse gas when the target article is recycled.

14. The information processing method according to claim 12, wherein the first comparison information is composed of information indicating the emission amount of the greenhouse gas of the target article when the target article is recycled, and the emission amount of the greenhouse gas of the target article when the target article is not recycled.

15. The information processing method according to claim 10, wherein:
when each of the components of the product includes a recycled article produced using a recycled material,
the emission information of the product includes second comparison information indicating a difference between an emission amount of the greenhouse gas of the recycled article and an emission amount of the greenhouse gas when the recycled article is replaced with a virgin article produced using a virgin material; and
the output of the emission information includes an output of the second comparison information.

16. The information processing method according to claim 15, wherein the second comparison information is composed of information indicating the emission amount of the greenhouse gas of the recycled article and a reduction amount in an emission of the greenhouse gas achieved by replacing the virgin article with the recycled article.

17. The information processing method according to claim 15, wherein the second comparison information is composed of information indicating the emission amount of the greenhouse gas of the recycled article and the emission amount of the greenhouse gas of the virgin article.

18. The information processing method according to claim 10, wherein:
when an emission amount of the greenhouse gas of a target component included in the product is larger than an emission amount of the greenhouse gas of the same component included in another product of the same kind as the product,
the emission information includes flag information indicating that the emission amount of the greenhouse gas of the target component is larger than the emission amount of the greenhouse gas of the same component included in the other product; and
the output of the emission information includes an output of the flag information.

19. A non-transitory storage medium storing a program for causing a computer to execute an information processing method, the information processing method comprising:
receiving a request for a product search from a user terminal;
extracting product information of a product corresponding to the received request from a product database, the product information including emission information indicating an emission amount of greenhouse gas of each of components constituting the product; and
returning the extracted product information to the user terminal such that an output of the emission information for each of the components of the product is allowed.

20. The storage medium according to claim 19, wherein each of the components includes a packaging material for the product.
